(19) United States
(12) Patent Application Publication
(10) Pub. No.: US 2005/0022923 A1
(43) Pub. Date: Feb. 3, 2005

(54) Method for repairing fuel tanks

(76) Inventors: Gregory J. Korchnak, Howell, MI (US); Kenneth J. Ritzema, Clarkston, MI (US); Steven B. Swartzmiller, Clarkston, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/930,237

(22) Filed: Aug. 31, 2004

Related U.S. Application Data
(62) Division of application No. 09/935,900, filed on Aug. 23, 2001.

(51) Int. Cl. B29C 73/10; B32B 35/00

(52) U.S. Cl. 156/94; 156/281; 156/153; 264/36.15; 156/327

(57) ABSTRACT

A method for repairing fuel tanks having detected leaks comprises (1) filling the detected leaks by applying an adhesive over the detected leaks and allowing the adhesive to cure to seal the detected leaks or (2) providing a fuel tank having a surface with detected leaks, providing a patch having a surface to be attached to the fuel tank surface having detected leaks, coating one or both surfaces with an adhesive, applying the patch over the detected leak(s) such that the adhesive is interposed between the patch surface and the tank surface, pressing the patch against the tank and allowing the adhesive to cure to bond the two surfaces together.

### BACKGROUND OF THE INVENTION

The present invention relates to fuel tanks and, more particularly, to methods for repairing fuel tanks.

Fuel tanks can be damaged during the production process or during use. Presently, fuel tanks are repaired by welding, soldering, or gluing the local spot that appears to be leaking.

Because replacement fuel tanks are quite costly, it would be desirable to have a method for repairing fuel tanks which is less expensive than a replacement tank, and which is easily and speedily performed.

### SUMMARY OF THE INVENTION

In a first aspect, the present invention is a method for repairing fuel tanks which comprises providing a fuel tank having a surface with detected leaks, filling the detected leaks by applying an adhesive over the detected leaks and allowing the adhesive to cure to seal the detected leaks.

In a second aspect, the present invention is a method for repairing fuel tanks which comprises providing a fuel tank having a surface with detected leaks, providing a patch having a surface to be attached to the fuel tank surface, coating the tank surface and/or the patch surface with an adhesive, placing the patch over the detected leak(s) such that the adhesive is interposed between the tank surface and the patch surface, pressing the patch against the tank and allowing the adhesive to cure to bond the two surfaces together.

### BRIEF DESCRIPTION OF THE DRAWINGS

FIGS. 1a, 1b and 1c show patch or plug designs used for in-plant repairs.

FIG. 1C shows a “donut” design of a “patch” or “plug” for redundant sealing mechanism.

FIGS. 2a, 2b and 2c show patch or plug designs used for after-market and/or warranty repairs.

### DETAILED DESCRIPTION OF THE INVENTION

The fuel tank, patch and/or plug can be made of metal or a monolayer or multilayer plastic laminate.

The patch can be made also of woven or non-woven fabric or a composite material, such as a fiber composite.

Preferably, the fuel tank, patch and/or plug comprise a multilayer laminate structure having one or more layers of a low energy surface material and one or more layers of a polymer having fuel barrier property.

More preferably, the fuel tank, patch and/or plug comprise a three-layer laminate structure having two outer layers of a low energy surface material and a core layer of a polymer having fuel barrier property.

The multilayer or three-layer laminate structure can be prepared by known techniques, such as co-extrusion or slot casting, both of which are known in the art.

The patches can be prepared by cutting a piece of metal or a monolayer or multilayer laminate structure or fiber composite into the desired size and shape for the patch, or by using conventional thermoforming techniques. A typical thermoforming process comprises heating a thermoplastic sheet to its softening point and then shaping the sheet at a forming station utilizing various molds and/or vacuum or air pressure assists or plug assists.

The plugs can be made by known processes, such as those described in U.S. Pat. Nos. 4,058,234; 4,160,465; 4,058,234; and 4,160,465

Composites, such as fiber composites, are known in the art and are described, for example, in U.S. Pat. No. 5,458,258, incorporated herein by reference. A fiber composite typically comprises reinforcing fibers or filaments embedded in a resin matrix. The resin can be applied on the filaments using either the prepreg method or the wet winding method. In the prepreg method, the filament is impregnated with a liquid resin and partially cured and then usually stored at low temperature to retard the curing process until required for winding. In the wet winding method, the filaments are impregnated with liquid resin just before winding on the mandrel.

The low energy surface materials which can be employed in the practice of the present invention include any material which meets original equipment manufacturers' (OEM) requirements, such as, for example, polyolefins, polytetrafluoroethylene (PTFE), polyethylene terephthalate (PET), acetal (polyoxymethylene) homopolymers and copolymers, nylon, poly(butylene terephalate) (PBT), liquid crystal polymers, polyvinylidene fluoride (PVDF), polyvinylidene chloride (PVDC) and ethylene vinyl alcohol (EVOH).

The polyolefins which can be employed in the practice of the present invention for preparing the multilayer laminate structure include polypropylene, polyethylene, and copolymers and blends thereof, as well as ethylene-propylene-diene terpolymers.

The preferred polyolefins are polypropylene, linear high density polyethylene (HDPE), heterogeneously-branched linear low density polyethylene (LLDPE) such as DOWLEX™ polyethylene resin (a trademark of The Dow Chemical Company), heterogeneously branched ultra low linear density polyethylene (ULDPE) such as ATTANE™ ULDPE (a trademark of The Dow Chemical Company); homogeneously-branched, linear ethylene/α-olefin copolymers such as TAFMER™ (a trademark of Mitsui Petrochemicals Company Limited) and EXACT™ (a trademark of Exxon Chemical Company); homogeneously branched, substantially linear ethylene/α-olefin polymers such as AFFINITY™ (a trademark of The Dow Chemical Company) and ENGAGE® (a trademark DuPont Dow Elastomers L.L. C) of polyolefin elastomers, which can be prepared as disclosed in U.S. Pat. Nos. 5,272,236 and 5,278,272; and high pressure, free radical polymerized ethylene polymers and copolymers such as low density polyethylene (LDPE), ethylene-acrylic acid (EAA) copolymers such as PRIMACOR™ (trademark of The Dow Chemical Company), and ethylene-vinyl acetate (EVA) copolymers such as ESCORENE™ polymers (a trademark of Exxon Chemical Company), and ELVAX™ (a trademark of E.I. du Pont de Nemours & Co.).

The more preferred polyolefins are the homogeneously-branched linear and substantially linear ethylene copolymers with a density (measured in accordance with ASTM D-792) of 0.85 to 0.99 g/cm³, a weight average molecular weight to number average molecular weight ratio (Mw/Mn) from 1.5 to 3.0, a measured melt index (measured in accordance with ASTM D-1238 (190/2.16)) of 0.01 to 100 g/10 min, and an I10/I2 of 6 to 20 (measured in accordance with ASTM D-1238 (190/10)). The most preferred polyolefin is a high density polyethylene. In general, high density polyethylene (HDPE) has a density of at least about 0.94 grams per cubic centimeter (g/cc) (ASTM Test Method D-1505). HDPE is commonly produced using techniques similar to the preparation of linear low density polyethylenes. Such techniques are described in U.S. Pat. Nos. 2,825,721; 2,993,876; 3,250,825 and 4,204,050. The preferred HDPE employed in the practice of the present invention has a density of from 0.94 to 0.99 g/cc and a melt index of from 0.01 to 35 grams per 10 minutes as determined by ASTM Test Method D-1238.

The polymers having fuel barrier property which can be employed in the practice of the present invention for preparing the plastic fuel tank and the patch or plug include polyamides, polyetrafluroethylene (PTFE), polyamides, fluoroelastomers, polyacetal homopolymers and copolymers, sulfonated and fluorinated HDPE, ethylene vinyl alcohol polymers and copolymers, hydroxy-functionalized polyethers and polyesters, and branched polyesters.

Specific examples of polyamides include nylon 6, nylon 66, nylon 610, nylon 9, nylon 11, nylon 12, nylon 6/66, nylon 66/610, nylon 6/11, AMODEL™, (a trademark of BP Amoco) and ZYTEL HTN™ (a trademark of E.I. du Pont de Nemours & Co.).

The tie layer, also commonly referred to as an adhesive layer, which can be employed in the practice of the present invention for adhering one layer to an adjacent layer of the multilayer structure is made of an adhesive material, such as a modified polyethylene elastomer. Preferably, the adhesive material is a maleic anhydride grafted polyethylene or polypropylene such as ADMER™ (trademark of Mitsui Petrochemicals) adhesive resin or ethylene-vinyl acetate copolymer resins such as ELVAX™ (trademark of DuPont).

The adhesives which can be employed in the practice of the present invention for repairing fuel tanks include those adhesives which can support a load of 1334N.

Advantageously, the adhesive has a fuel vapor permeation rate of not more than 46 g-mm/m²/day and, more advantageously, not more than 12 g-mm/m²/day, as determined by ASTM E 96-94.

Preferably the adhesives are those which bond to low energy surface plastic materials, such as the adhesive commercially known as LEA and described in an advertisement in the SPE Plastics Engineering magazine, March 2001 page 22 (need more information on this); and adhesives comprising an amine/organoborane complex, such as those described in a series of patents issued to Skoultchi (U.S. Pat. Nos. 5,106,928, 5,143,884, 5,286,821, 5,310,835 and 5,376,746), all patents incorporated herein by reference. These patents disclose a two-part initiator system that is reportedly useful in acrylic adhesive compositions. The first part of the two-part system includes a stable organoborane/amine complex and the second part includes a destabilizer or activator such as an organic acid or an aldehyde. The organoborane compound of the complex has three ligands which can be selected from C₁₋₁₀ alkyl groups or phenyl groups. Useful amines disclosed include octylamine, 1,6 diaminohexane, diethylamine, dibutylamine, diethylenetriaamine, dipropylenediamine, 1,3 propylene diamine, and 1,2 propylene diamine.

Other preferred adhesives which can be employed in the practice of the present invention for repairing fuel tanks include those adhesives disclosed by Zharov et al. in a series of U.S. patents (U.S. Pat. No. 5,539,070; U.S. Pat. No. 5,690,780; and U.S. Pat. No. 5,691,065), all patents incorporated herein by reference. These patents describe polymerizable acrylic compositions which are particularly useful as adhesives wherein organoborane/amine complexes are used to initiate cure. The organoboranes used have three ligands attached to the borane atom which are selected from C₁₋₁₀ alkyl groups and phenyl. The amine is an alkanol amine or a diamine where the first amine group can be a primary or secondary amine and the second amine is a primary amine. It is disclosed that these complexes are good for initiating polymerization of an adhesive which bonds to low surface energy substrates.

Pocius in a series of patents (U.S. Pat. No. 5,616,796; U.S. Pat. No. 5,6211,43; U.S. Pat. No. 5,681,910; U.S. Pat. No. 5,686,544; U.S. Pat. No. 5,718,977; and U.S. Pat. No. 5,795,657), all patents incorporated herein by reference, discloses amine/organoborane complexes with a variety of amines such as polyoxyalkylene polyamines and polyamines which are the reaction product of diprimary amines and compound having at least two groups which react with a primary amine.

The most preferred adhesive materials which can be employed in the practice of the present invention for repairing fuel tanks comprise a preferred class of an amine/organoborane complex described in copending application U.S. Ser. No. 09/466,321, filed Dec. 17, 1999, incorporated herein by reference. These adhesives are formulated such that no preparation or pre-treatment of the surfaces to be bonded is required.

The organoborane in the amine/organoborane complex is a trialkyl borane or alkyl cycloalkyl borane and the amine is selected from the group consisting of (1) amines having an amidine structural component; (2) aliphatic heterocycles having at least one nitrogen in the heterocyclic ring wherein the heterocyclic compound may also contain one or more nitrogen atoms, oxygen atoms, sulfur atoms, or double bonds in the heterocycle; (3) primary amines which in addition have one or more hydrogen bond accepting groups wherein there are at least two carbon atoms, preferably at least three carbon atoms, between the primary amine and the hydrogen bond accepting group, such that due to inter- or intramolecular interactions within the complex the strength of the B—N bond is increased; and (4) conjugated imines.

Preferably, the trialkyl borane or alkyl cycloalkyl borane corresponds to Formula 1:
BR²)3 Formula 1
wherein B represents Boron; and R² is separately in each occurrence a C₁₋₁₀ alkyl, C₃₋₁₀ cycloalkyl, or two or more of R² may combine to form a cycloaliphatic ring. Preferably R² is C₁₋₄ alkyl, even more preferably C₂₋₄ alkyl, and most preferably C₃₋₄ alkyl.

The amine comprises a compound having a primary amine and one or more hydrogen bond accepting groups, wherein there are at least two carbon atoms, preferably at least about three, between the primary amine and hydrogen bond accepting groups. Hydrogen bond accepting group means herein a functional group that through either inter- or intramolecular interaction with a hydrogen of the borane-complexing amine increases the electron density of the nitrogen of the amine group complexing with the borane. Preferred hydrogen bond accepting groups include primary amines, secondary amines, tertiary amines, ethers, halogen, polyethers, and polyamines.

Preferably, the amine corresponds to Formula 2:
NH₂(CH₂_{b}C(R¹)₂ₐ X Formula 2
wherein R¹ is separately in each occurrence hydrogen or a C₁₋₁₀ alkyl or C₃₋₁₀ cycloalkyl; X is hydrogen bond accepting moiety; a is an integer of 1 to 10; and b is separately in each occurrence an integer of 0 to 1, and the sum of a and b is from 2 to 10. Preferably R¹ is hydrogen or methyl. Preferably X is separately in each occurrence a hydrogen accepting moiety with the proviso that when the hydrogen accepting, moiety is an amine it is a tertiary or a secondary amine. More preferably X is separately in each occurrence —N(R⁸)ₑ, —OR¹⁰, or a halogen wherein R⁸ is separately in each occurrence C₁₋₁₀ alkyl, C₃₋₁₀ cycloalkyl or —(C(R¹)₂)_{d}-W; R¹⁰ is separately in each occurrence, C₁₋₁₀ alkyl, C₃₋₁₀ cycloalkyl, or —(C(R¹)₂)_{d}-W; and e is 0, 1, or 2. More preferably X is —N(R⁸)₂ or —OR¹⁰. Preferably, R⁸ and R¹⁰ are C₁₋₄ alkyl or —(C(R¹)₂)_{d}-W, more preferably C₁₋₄ alkyl and most preferably methyl; W is separately in each occurrence hydrogen or C₁₋₁₀ alkyl or X and more preferably hydrogen or C₁₋₄ alkyl. Preferably, a is about 1 or greater and more preferably 2 or greater. Preferably a is about 6 or less, and most preferably about 4 or less. Preferably, b is about 1. Preferably, the sum of a and b is an integer about 2 or greater and most preferably about 3 or greater. Preferably the sum of a and b are about 6 or less and more preferably about 4 or less. Preferably d is separately in each occurrence an integer of 1 to 4, more preferably 2 to 4, and most preferably 2 to 3.

Among preferred amines corresponding to Formula 2 are dimethylaminopropyl amine, methoxypropyl amine, dimethylaminoethylamine, dimethylaminobutylamine, methoxybutyl amine, methoxyethyl amine, ethoxypropylamine, propoxypropylamine, amine terminated polyalkylene ethers (such as trimethylolpropane tris(poly(propyleneglycol), amine terminated)ether), aminopropylmorpholine, isophoronediamine, and aminopropylpropanediamine.

In one embodiment the preferred amine complex corresponds to Formula 3:
(R²₃B←NH₂(CH₂_{b}C(R¹)2ₐ Formula 3
wherein R¹, R², X, a and b are as defined hereinbefore.

In another embodiment the amine is an aliphatic heterocycle having at least one nitrogen in the heterocycle. The heterocyclic compound may also contain one or more of nitrogen, oxygen, sulfur or double bonds.

In addition, the heterocycle may comprise multiple rings wherein at least one of the rings has a nitrogen in the ring. Preferably the aliphatic heterocylic amine corresponds to Formula 4: 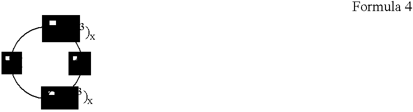
wherein R³ is separately in each occurrence hydrogen, a C₁₋₁₀ alkyl or C₃₋₁₀ cycloalkyl; Z is separately in each occurrence oxygen or NR⁴ wherein R⁴ is hydrogen, C₁₋₁₀ alkyl, or C₆₋₁₀ aryl or alkaryl; x is separately in each occurrence an integer of 1 to 10, with the proviso that the total of all occurrences of x should be from 2 to 10; and y is separately in each occurrence 0 or 1. Preferably, R³ is separately in each occurrence hydrogen or methyl. Preferably Z is NR⁴. Preferably, R⁴ is hydrogen or C₁₋₄ alkyl, and more preferably hydrogen or methyl. Preferably x is from 1 to 5 and the total of all the occurrences of x is 3 to 5. Preferred compounds corresponding to Formula 4 include morpholine, piperidine, pyrolidine, piperazine, 1,3,3 trimethyl 6-azabicyclo[3,2,1] octane, thiazolidine, homopiperazine, aziridine, 1,4-diazabicylo[2.2.2]octane (DABCO), 1-amino-4-methylpiperazine, and 3-pyrroline. Complexes using aliphatic heterocyclic amines preferably correspond to Formula 5: 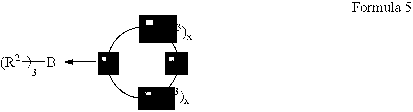
wherein R², R³, Z, x and y are as defined hereinbefore.

In yet another embodiment, the amine which is complexed with the organoborane is an amidine. Any compound with amidine structure wherein the amidine has sufficient binding energy as described hereinbefore with the organoborane, may be used. Preferable amidine compounds correspond to Formula 6: 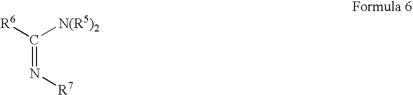
wherein R⁵, R⁶, and R⁷ are separately in each occurrence hydrogen, a C₁₋₁₀ alkyl or C₃₋₁₀ cycloalkyl; two or more of R⁵, R⁶, and R⁷ may combine in any combination to form a ring structure, which may have one or more rings. Preferably R⁵, R⁶ and R⁷ are separately in each occurrence hydrogen, C₁₋₄ alkyl or C₅₋₆ cycloalkyl. Most preferably R⁷ is H or methyl. In the embodiment where two or more of R⁵, R⁶ and R⁷ combine to form a ring structure the ring structure is preferably a single or a double ring structure. Among preferred amidines are 1,8 diazabicyclo[5,4]undec-7-ene; tetrahydropyrimidine; 2-methyl-2-imidazoline; and 1,1,3,3-tetramethylguanidine.

The organoborane amidine complexes preferably correspond to Formula 7: 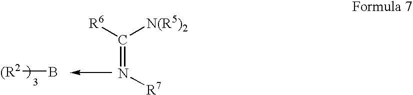
wherein R², R⁵, R⁶ and R⁷ are as defined earlier.

In yet another embodiment, the amine which is complexed with the organoborane is a conjugated imine. Any compound with a conjugated imine structure, wherein the imine has sufficient binding energy as described hereinbefore with the organoborane, may be used. The conjugated imine can be a straight or branched chain imine or a cylic imine. Preferable imine compounds correspond to Formula 8:
NR⁷═CR⁹—(CR⁹═CR⁹ )_{c}—Y Formula 8
wherein Y is independently in each occurrence hydrogen, N(R⁴)₂, OR⁴, C(O)OR⁴, halogen or an alkylene group which forms a cyclic ring with an R⁷ or R⁹, R⁴ is hydrogen, C₁₋₁₀ alkyl, or C₆₋₁₀ aryl or alkaryl. Preferably R⁴is hydrogen or methyl. R⁷is as described previously. R⁹ is independently in each occurrence hydrogen, Y, C₁₋₁₀ alkyl, C₃₋₁₀ cycloalkyl-, (C(R⁹)₂—(CR⁹═CR⁹)_{c}—Y or two or more of R⁹ can combine to form a ring structure provided the ring structure is conjugated with respect to the double bond of the imine nitrogen; and c is an integer of from 1 to 10. Preferably, R⁹ is hydrogen or methyl.

Y is preferably N(R⁴)₂, or OR⁴, or an alkylene group which forms a cyclic ring with R7 or R⁹.

Y is more preferably N(R⁴)₂ or an alkylene group which forms a cyclic ring with R⁷ or R⁹. Preferably, c is an integer of from 1 to 5, and most preferably about 1. Among preferred conjugated imines useful in this invention are 4-dimethylaminopyridine; 2,3-bis(dimethylamino)cyclopropeneimine;(dimethylamine)acroleinimine; and 3-(dimethylamino)methacroleinimine.

Among preferred cyclic imines are those corresponding to the following structures:

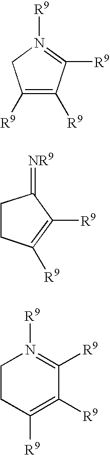

The complexes with the conjugated imines preferably correspond to Formula 9:
(R²₃B←NR⁷═CR⁹—(CR⁹═CR⁹)_{c} Formula 9
wherein R², R⁷, R⁹, c and Y are as defined hereinbefore.

The molar ratio of amine compound to borane compound in the complex is relatively important. In some complexes if the molar ratio of amine compound to organoborane compound is too low, the complex is pyrophoric. Preferably the molar ratio of amine compound to organoborane compound is from 1.0:1.0 to 3.0:1.0. Below the ratio of about 1.0:1.0 there may be problems with polymerization, stability of the complex and for adhesive uses, adhesion. Greater than about a 3.0:1.0 ratio may be used although there is no benefit from using a ratio greater than about 3.0:1.0. If too much amine is present, this may negatively impact the stability of the adhesive or polymer compositions. Preferably the molar ratio of amine compound to organoborane compound is from 2.0:1.0 to 1.0:1.0.

The polymerizable compounds which may be used in the polymerization compositions of the adhesive include acrylate and/or methacrylate based compounds, with methylmethacrylate, butylmethacrylate, 2-ethylhexylmethacrylate, isobornylmethacrylate, tetrahydrofurfuryl methacrylate, and cyclohexylmethylmethacrylate as the most preferred.

Adhesives which do not bond to low energy surface materials can be used also in the practice of the present invention. These adhesives require pretreatment of the surfaces of the materials to be joined. Such adhesives, include, for example, polyurethane-, epoxy-, polyimide-, phenolic/resorcinolic-, or acrylate-based adhesives.

Surface pretreatments of metals include, for example, phosphate conversion coating, passivation, pickling, grit-blasting, various plasma treatments, e.g. oxygen, helium, argon, air, nitrous oxide, carbon dioxide, nitrogen, and ammonia; flame-carried silane (Pyrosil®), sandpaper delivered silicate, various solvent soaks and wipes, abrading, alkali cleaning, silane-based primers, peel ply and artificial surface coatings i.e. e-coat.

Surface pretreatments of plastics include, for example, etching, aluminum-alkali and electrochemical treatments, solvent cleaning, flame treatments, chemical treatments, plasma treatments, artificial coatings, UV irradiation and photochemical treatments.

The adhesive can be applied to the detected leaks, fuel tank surface with detected leaks or to the patch surface with the aid of customary methods, for example, by spraying, knife coating, dipping or brushing.

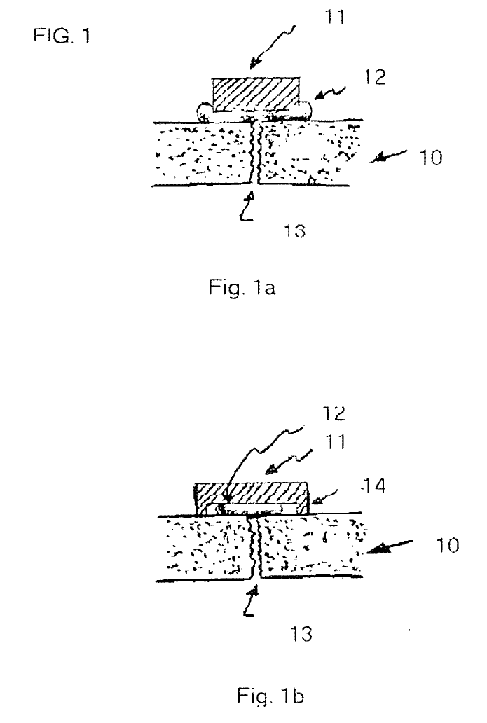

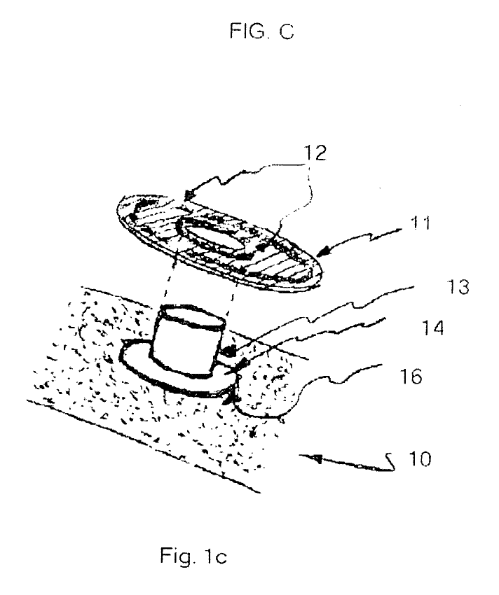

Referring now to FIGS. 1a and 1b, there is shown HDPE fuel tank 10 with a crack puncture 13. Disposed directly over crack/puncture 13 is a plastic patch or plug 21 attached to the surface immediately surrounding crack/puncture 13 by adhesive 12. Adhesive 12 comprises the most preferred adhesive as described previously.

In FIG. 1b, there is shown stand off 14 which limits the compression of adhesive 12.

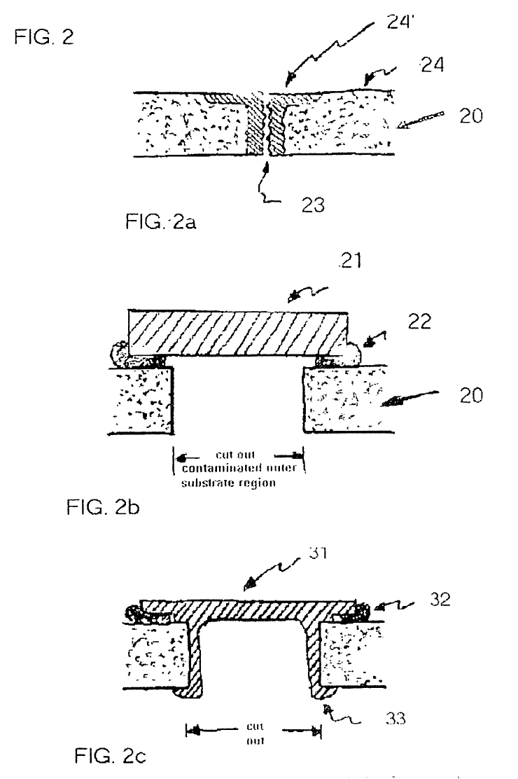

Shown in FIGS. 2a, 2b and 2c is an example of the use of a patch or plug after fuel contamination of the exterior surface of a fuel tank. The crack/puncture 23 is cut out to a diameter that would exceed fuel contamination of the outer substrate. Patch or plug 21 is applied over the crack or puncture. Patch or plug 21 is attached to the fuel tank 20 by adhesive 22. In FIG. 2, there is shown tank outer substrate 34 and its portion 34′ contaminated with fuel. The contaminated portion 24′ is cut out as shown in FIG. 2B and patch 21 is placed over tank 20 as shown to cover the hole left by the cut out contaminated portion 24′. Patch 21 is attached to the tank by adhesive 22. In FIG. 2C, patch 21 is provided with snapfit 23. Snap fit 23 and/or an interference fit, or other mechanical attachment, such as, for example, a clip, clamp or nut and bolt, is used to temporarily hold the patch and the tank surface together while adhesive 22 cures to an acceptable green strength.

1. A method for repairing fuel tanks which comprises providing a fuel tank having a surface with detected leaks, filling the detected leaks by applying an adhesive over the detected leaks and allowing the adhesive to cure to seal the detected leaks.

2. The method of claim 1 wherein the adhesive comprises polymerizable acrylic composition and an amine/organoborane complex.

3. The method of claim 2 wherein the organoborane is a trialkyl borane or alkyl cycloalkyl borane and the amine is selected from the group consisting of (1) amines having an amidine structural component; (2) aliphatic heterocycles having at least one nitrogen in the heterocyclic ring wherein the heterocyclic compound may also contain one or more nitrogen atoms, oxygen atoms, sulfur atoms, or double bonds in the heterocycle; (3) primary amines which in addition have one or more hydrogen bond accepting groups wherein there are at least two carbon atoms, preferably at least three carbon atoms between the primary amine and the hydrogen bond accepting group, such that due to inter- or intramolecular interactions within the complex the strength of the B—N bond is increased; and (4) conjugated imines.

4-8. (cancelled).

9. The method of claim 1 wherein the fuel tank is made of stainless steel, pre-coated or post-coated low-carbon steel, aluminum, bronze, electroplated zinc, nickel or galvanneal.

10. The method of claim 1 wherein the fuel tank is made of metal or a multilayer structure having one or more layers of a polymer having fuel barrier property and one or more layers of a low energy surface material.

11. The method of claim 10 wherein the low energy surface material is high density polyethylene and the fuel barrier polymer is selected from the group consisting of polyamides, fluoroelastomers, polyacetal homopolymers and copolymers, sulfonated and fluorinated high density polyethylene, ethylene vinyl alcohol polymers and copolymers, hydroxy-functionalized polyethers and polyesters, and branched polyesters.

12. The method of claim 1 wherein the adhesive comprises an adhesive having fuel barrier property and which bonds to low energy surface materials.

13-19. (cancelled).

20. The method of claim 1, wherein the fuel tank is made of metal or a monolayer or multilayer plastic.

21. The method of claim 1 wherein the adhesive comprises a polyurethane-, epoxy-, polyimide-, phenolic/resorcinolic-. or acrylate-based adhesive.

22. The method of claim 1 wherein the fuel tank surface is cleaned and/or pre-treated to provide adequate bonding, between the adhesive and the fuel tank.

23. The method of claim 22 wherein the exterior and/or interior surface of the fuel tank is cleaned with water and or soap, or solvent.

24. The method of claim 22 wherein the exterior and/or interior surface of the fuel tank is sanded or sandblasted.

25-26. (cancelled).

27. The method of claim 12 wherein the adhesive exhibits a fuel vapor permeation rate of not more than about 46 g-mm/m²/day according to ASTM E 96-94.

28. The method of claim 12 wherein the adhesive exhibits a fuel vapor permeation rate of not more than about 12 g-mm/m²/day according to ASTM E 96-94.

29. A method according to claim 27 wherein the adhesive can support a load of 13334N.
